(19) United States
(12) Patent Application Publication
(10) Pub. No.: US 2005/0183358 A1
(43) Pub. Date: Aug. 25, 2005

(54) Structural panel for use in buildings

(75) Inventor: Michael Palmersten, Woodbury, MN (US)

Correspondence Address: CROMPTON, SEAGER & TUFTE, LLC, 1221 NICOLLET AVENUE, SUITE 800, MINNEAPOLIS, MN, 55403-2420, US

(73) Assignee: KJMM, INC.

(21) Appl. No.: 10/785,346

(22) Filed: Feb. 24, 2004

(51) Int. Cl. B29D 7/00; E04B 1/00; E04B 5/00; E04B 7/00

(52) U.S. Cl. 52/268

(57) ABSTRACT

A structural panel for use in building construction, which may include a first skin having a first face, a second skin having a first face spaced apart from the first skin first face, a reinforcing member having a first surface fixed to the first skin first face and a second surface fixed to the second skin first face, a first foam piece having a first surface fixed to the first skin first face, a second surface fixed to the second skin first face, and a third surface facing a third surface of the reinforcing member, and a second foam piece having a first surface fixed to the first skin first face, a second surface fixed to the second skin first face, and a third surface facing a fourth surface of the reinforcing member.

### FIELD

The present invention relates to modular building panels or structural insulated panels utilized to fabricate the walls, ceilings, floors, etc. of houses, room additions, porches, mudrooms, sheds, outbuildings, and the like.

### BACKGROUND

The use of modular building panels is a popular method for economically adding additional enclosed structures to a pre-existing structure. Examples of new structures include room additions and enclosed porches. In many cases these additional room enclosures are used for leisure activities such as reading, watching television, and visiting with guests.

Typically modular building panels cost less than conventional construction materials. Modular building panels may be quickly disposed in an edge to edge configuration to form walls, roofs, etc. The assembly time required to build a structure with modular building panels is typically much less than when building using conventional construction methods. The time and labor savings provides additional cost savings.

Structures built with modular building panels, like other structures, are often exposed to the wind, sun rain, hail, and even seismic activity. It is desirable that structures built with modular building panels be durable enough to withstand exposure to these elements.

Moreover, there is a longstanding and continuing trend in dwelling construction to build larger houses and larger rooms and living spaces within houses. There is also a trend towards higher ceilings and vaulted ceilings. Therefore, there is a continuous need for stronger structural panels that can span greater distances to build larger roof spans or floor spans without additional support.

### SUMMARY

The description pertains to a structural panel having a core layer disposed between a first skin and a second skin. The core layer includes two foam portions and an intermediate reinforcing portion having greater rigidity than the foam. Each of the foam portions and the intermediate reinforcing portion may extend between the first skin and the second skin. The intermediate reinforcing portion may be a honeycomb material with the cells extending between the two skins, or may be a sheet metal material or other suitable material. The intermediate layer and the first and second skins would form an I-beam configuration.

The description also pertains to a structural panel having a core layer disposed between a first skin and a second skin. The core layer includes a first foam portion with an exposed surface, a first reinforcing portion disposed between the first foam portion and a second foam portion, a second reinforcing portion disposed between the second foam portion and a third foam portion, the third foam portion having an exposed surface. The first and second reinforcing portions extend between the first and second skins and form a double I-beam configuration.

Another example embodiment pertains to a structural panel having a core layer disposed between a first skin and a second skin. The core layer has first reinforcing portion having an exposed surface, a first foam portion disposed between the first reinforcing portion and a second reinforcing portion, a second foam portion disposed between the second reinforcing portion and a third reinforcing portion, the third reinforcing portion having an exposed surface. The reinforcing portions extend between the first and second skins and together with the skins form a triple I-beam configuration.

The above summary of some embodiments is not intended to describe each disclosed embodiment or every implementation of the present invention. For example, in each of the embodiment briefly described above, additional foam portions or reinforcing portions may be added. The figures and detailed description which follow more particularly exemplify these embodiments.

### BRIEF DESCRIPTION OF THE DRAWINGS

The invention may be more completely understood in consideration of the following detailed description in connection with the accompanying drawings in which:

FIG. 1 is an isometric diagrammatic view of a structural panel;

FIG. 2 is a diagrammatic cross-sectional view of another structural panel;

FIG. 3 is a diagrammatic cross-sectional view of another structural panel

FIG. 4 is a diagrammatic cross-sectional view of another structural panel; and

FIG. 5 is an isometric diagrammatic view of another structural panel.

### DETAILED DESCRIPTION

The following detailed description should be read with reference to the drawings, in which like elements in different drawings are numbered identically. The drawings which are not necessarily to scale, depict selected embodiments and are not intended to limit the scope of the invention.

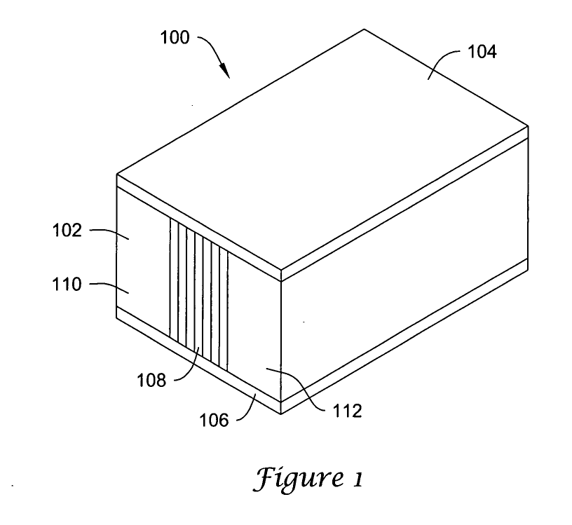

FIG. 1 is an isometric diagrammatic view of a structural panel 100 according to the invention. Structural panel 100 includes a core layer 102 bonded between a first skin 104 and a second skin 106. Core layer 102 includes a reinforcing member 108 disposed between a first foam section 110 and a second foam section 112.

Foam sections 110 and 112 may provide insulation and sound dampening characteristics. Foam section 110 and 112 may be made from materials which exhibit good shear strength and stiffness for low density materials. It may also be desirable for these materials to have good compressive loading characteristics. Suitable materials may include such foams as expanded polystyrene (EPS) foam, extruded polystyrene foam, closed-cell polyvinyl chloride (PVC) foams, polyurethane foams, polymethyl methacrylamide foams, acrylic foams, styrene acrylonitrile foams, expanded polyetherimide/polyether sulphone foams, or equivalents.

Reinforcing member 108 is a material which exhibits superior torsional stiffness for its volume when supported by foam sections and attached to the skins. Suitable materials may include sheet metal such as sheet aluminum or sheet steel of, for example, between 0.020 and 0.040 inches thick, or between 0.024 and 0.032 inches thick. Other suitable materials may include honeycomb cores made from cardboard, thermoplastic, nomex, aluminum or other suitable material, or metal foams such as aluminum foam. Suitable honeycomb material may be manufactured according to processes described in patent no. 6,256,959 to Palmersten, which is herein incorporated by reference. The honeycomb may be, for example, between 0.2 and 8.0 inches thick, or between 0.25 and 2.25 inches thick.

A honeycomb material is formed when another material is fashioned to form a series of repeating cells, which are generally parallel to each other. A honeycomb material is therefore generally anisometric, having differing properties such as compressive strength on different axes. Therefore, to maximize the torsional stiffness of a structural panel using a honeycomb material for the intermediate reinforcing member, the cells of the honeycomb material should be oriented generally perpendicularly to skins 104 and 106. As can be seen in FIG. 1, reinforcing member 108 is a honeycomb material with the cells oriented perpendicularly to the skins.

Skins 104 and 106 together with reinforcing member 108 form an I-beam which may improve torsional rigidity. Each skin, if by itself, would tend to bend about its own center of moment. By connecting skin 104 and 106 together though reinforcing member 108, each skin will bend about a center of moment of the two skins and the reinforcing member together. Each skin has effectively become the outer layer of a thicker object. Because flexural stiffness is proportional to the cube of the thickness, connecting the skins through the reinforcing member thereby dramatically improves the flexural stiffness of the structural panel.

One example structural member has a core layer 3″ thick, including a NOMEX honeycomb reinforcing member ¾″ wide between two polystyrene foam sections which are 4″ wide. The skins are 0.024″ steel bonded to the core with an adhesive. The structural member is 16′ long.

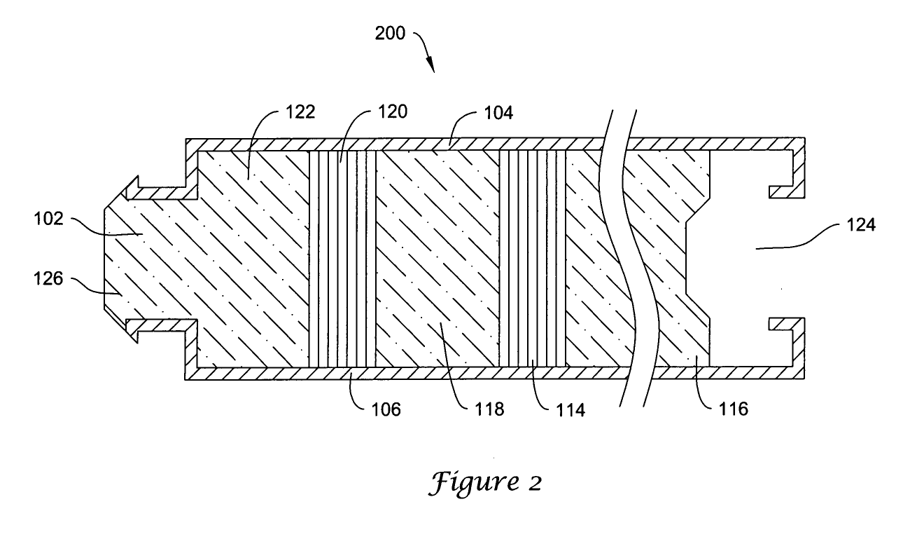

FIG. 2 is a cross-sectional diagrammatic view of a structural panel 200. Structural panel 200 has a core 102 bonded between a first skin 104 and a second skin 106. Core 102 includes a first reinforcing member 114 disposed between a first foam section 116 and a second foam section 118. A second reinforcing member 120 is disposed between second foam section 118 and a third foam section 122. Skins 104 and 106 and first foam section 116 form a female interlocking edge 124. Similarly, skins 104 and 106 and third foam section 122 form a male interlocking edge 126. Female interlocking edge 124 is configured to receive and retain a male interlocking edge of another structural member. This arrangement may ease the rapid joining of a series of structural members. The configuration of edges 124 and 126, including skins 104 and 106, are only one of numerous possible and contemplated configurations and the particular configuration shown and described is not intended to be limiting. Moreover, the inventor contemplates that other panels, such as structural panels 100 and 300 (described below) are amenable to the addition of similar interlocking edges for similar purposes.

Foam sections 116, 118 and 122 may be made from any of the foams described above with respect to foam section 110. Likewise, reinforcing members 114 and 120 may be made from any of the materials described above with respect to reinforcing member 108.

When skins 104 and 106 are bonded to reinforcing members 114 and 120, a double I-beam configuration is created. This configuration has the advantages described above with respect to the I-beam configuration and has additional stiffness created by the second reinforcing member supported by the foam.

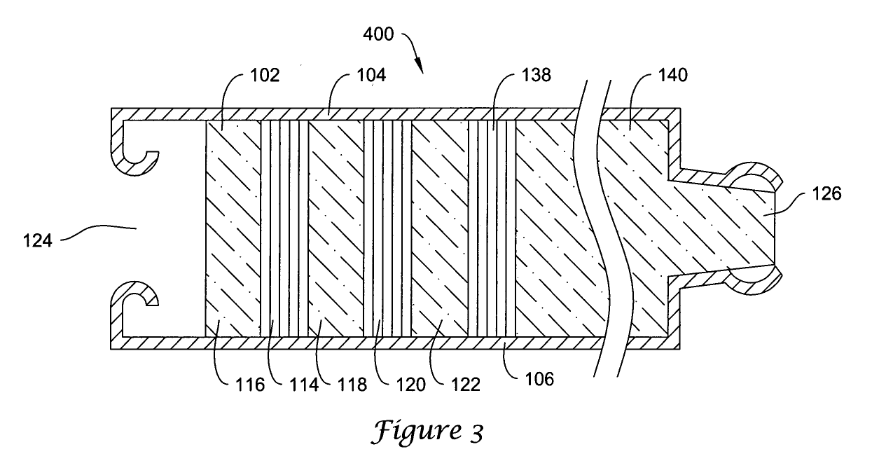

FIG. 3 is a diagrammatic cross-sectional view of a structural panel 400, which includes a core 102 bonded between a first skin 104 and a second skin 106. Core 102 includes a first reinforcing member 114 disposed between a first foam section 116 and a section foam section 118. A second reinforcing member 120 is disposed between second foam section 118 and a third foam section 122, and a third reinforcing member 138 is disposed between third foam section 122 and a fourth foam section 140. Skins 104 and 106 and first foam section 116 form a female interlocking edge 124. Similarly, skins 104 and 106 and fourth foam section 140 form a male interlocking edge 126. Other interlocking edge configurations are contemplated, and core 102 may have other configurations. For example, the number, spacing or configuration of the reinforcing members may be varied. Any suitable materials, such as those herein described, may be used with structural panel 400.

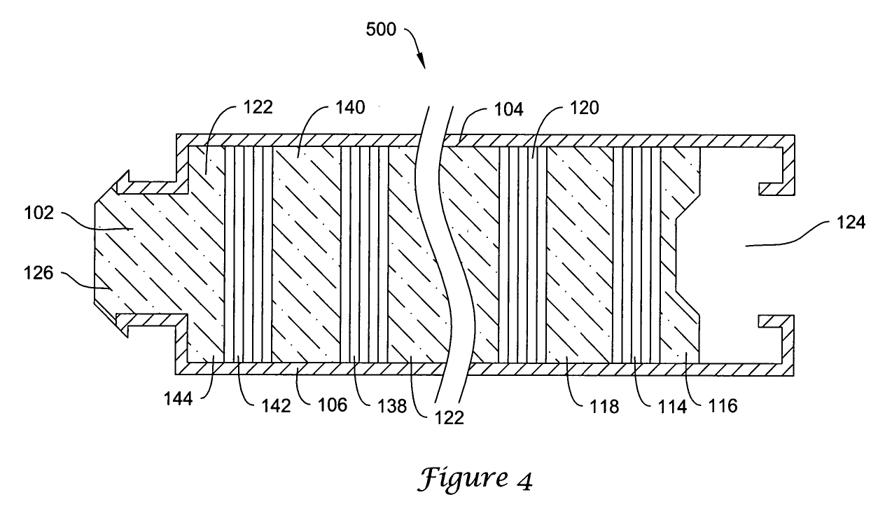

FIG. 4 is a diagrammatic cross-sectional view of a structural panel 500, which includes a core 102 bonded between a first skin 104 and a second skin 106. Core 102 includes a first reinforcing member 114 disposed between a first foam section 116 and a section foam section 118. A second reinforcing member 120 is disposed between second foam section 118 and a third foam section 122, and a third reinforcing member 138 is disposed between third foam section 122 and a fourth foam section 140. A fourth reinforcing member 142 is disposed between fourth foam section 140 and a fifth foam section 144. Skins 104 and 106 and first foam section 116 form a female interlocking edge 124. Similarly, skins 104 and 106 and fourth foam section 140 form a male interlocking edge 126. Other interlocking edge configurations are contemplated, and core 102 may have other configurations. For example, the foam sections 116 and 102 may be made from a first foam material and foam sections 118, 122, and 140 may be made from a second foam material. Any suitable materials, such as those herein described, may be used with structural panel 500.

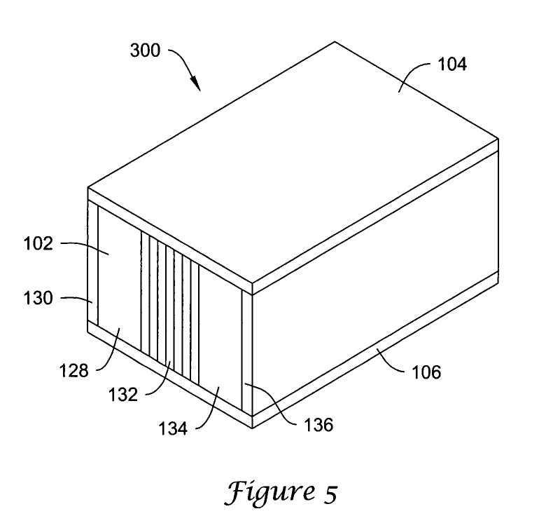

FIG. 5 is an isometric diagrammatic view of a structural panel 300, which includes core 102 bonded between a first skin 104 and a second skin 106. Core 102 has a first foam section 128 disposed between a first reinforcing member 130 and a second reinforcing member 132. A second foam section 134 is disposed between second reinforcing member 132 and a third reinforcing member 136. Embodiments where structural panel 300 includes interlocking edges as disclosed above with respect to structural panel 200 are contemplated. Foam sections 128 and 134 may be made of one or more of the materials discussed above with respect to foam section 110. Reinforcing members 130, 132 and 136 may be made from one or more of the materials discussed above with respect to reinforcing member 108. In the embodiment of FIG. 3 for example, reinforcing members 130 and 136 are made from aluminum sheet metal and reinforcing member 134 is made from an aluminum honeycomb material.

Structural panel 300 creates a 3 I-beam configuration, which provides further flexural stiffness for the reasons discussed above. This panel also provides protection to the side surfaces of the foam sections, which may be advantageous in certain circumstances. For example, the foam sections may be more sensitive to environmental exposure than the reinforcing members.

Other embodiments are contemplated. For example, embodiment with four or more reinforcing members are contemplated. In another example embodiment, one or more of the foam portions includes more than one layer and may include a layer such as a sheet metal or fiberboard panel designed to retain fasteners between two foam layers. In another example embodiment, each panel may include a polymeric or metal edge to provide additional protection to the core.

A structural panel may be made by first forming the core. For example, two foam portions are bonded to a reinforcing member by adhesive, epoxy, or melt bonding. The product of this process is then trimmed to form the core. Skins may then be cut to size from sheet metal or other suitable material. It may be desirable to shape the skin edges to form interlocking male and female edges prior to assembly. The skins may then be bonded to the core and particularly to the reinforcing member by adhesive, melt bonding, friction welding, laser welding, or other suitable bonding process.

Alternatively, a structural panel may be manufacturing according to the following process. The reinforcing member, for example a honeycomb material is provided and cut to size. Each skin is cut and shaped to the desired configuration. The reinforcing member is bonded to each skin using adhesive, welding, or other suitable process. The foam portions of the core are then formed in place by injecting a liquid foam precursor between the skins. The foam may be allowed to set and cure if needed, and then it is trimmed to produce the structure panel.

Numerous advantages of the invention covered by this document have been set forth in the foregoing description. It will be understood, however, that this disclosure is, in many respects, only illustrative. Changes may be made in details, particularly in matters of shape, size, and arrangement of parts or order of steps without exceeding the scope of the invention. The invention's scope is, of course, defined in the language in which the appended claims are expressed.

1. A structural panel for use in building construction, comprising
a first skin having a first face;
a second skin having a first face spaced apart from the first skin first face;
a reinforcing member having a first surface fixed to the first skin first face and a second surface fixed to the second skin first face;
a first foam piece having a first surface fixed to the first skin first face, a second surface fixed to the second skin first face, and a third surface facing a third surface of the reinforcing member; and
a second foam piece having a first surface fixed to the first skin first face, a second surface fixed to the second skin first face, and a third surface facing a fourth surface of the reinforcing member.

2. The structural panel of claim 1, further comprising a first interlocking edge and a second interlocking edge, the first interlocking edge configured to interlock with a second interlocking edge of a second panel.

3. The structural panel of claim 2, wherein the first and second interlocking edges are formed from the first and second skins.

4. The structural panel of claim 2, wherein the reinforcing member is substantially parallel to the first interlocking edge.

5. The structural panel of claim 1, wherein the first and second foam pieces are fixed to the reinforcing member.

6. The structural panel of claim 1, wherein the first skin comprises aluminum.

7. The structural panel of claim 1, wherein the first skin comprises steel.

8. The structural panel of claim 1, wherein the reinforcing member comprises metal.

9. The structural panel of claim 8, wherein the width between the third and fourth surfaces of the reinforcing member is greater than 0″ and less than 0.40″.

10. The structural panel of claim 1, wherein the reinforcing member comprises sheet metal.

11. The structural panel of claim 1, wherein the reinforcing member comprises a honeycomb material.

12. The structural panel of claim 11, wherein the reinforcing member comprises a paper honeycomb.

13. The structural panel of claim 11, wherein the reinforcing member comprises a nomex honeycomb.

14. The structural panel of claim 11, wherein the reinforcing member comprises an aluminum honeycomb.

15. The structural panel of claim 11, wherein the width between the third and fourth surfaces of the reinforcing member is greater than 0″ and less than 1.25″.

16. The structural panel of claim 1, wherein the reinforcing member comprises an aluminum foam.

17. The structural panel of claim 1, wherein the third surface of the first insulation piece abuts the third surface of the reinforcing member.

18. The structural panel of claim 17, wherein the third surface of the first insulation piece is bonded to the third surface of the reinforcing member.

19. The structural panel of claim 1, further comprising
a third foam piece extending between the first skin and the second skin; and
a second reinforcing member extending between the first skin and the second skin disposed between the second foam piece and the third foam piece;

20. The structural panel of claim 1, further comprising
a second reinforcing member extending between the first skin and the second skin, having a first surface facing the first foam piece and a second exposed surface opposite the first surface; and
a third reinforcing member extending between the first skin and the second skin, having a first surface facing the second foam piece and a second exposed surface opposite the first surface.

21. A method of making a panel, comprising
providing a first piece of foam;
providing a first reinforcing member;
providing a second piece of foam;
forming a first planar surface including a surface from each of the first piece of foam, the first reinforcing member, and the second piece of foam;
forming a second planar surface including a surface from each of the first piece of foam, the first reinforcing member, and the second piece of foam;
providing a first skin;
providing a second skin;
applying a first skin to the first planar surface; and
applying a second skin to the second planar surface.

22. The method of claim 21, further comprising the step of positioning the first reinforcing member between the first piece of foam and the second piece of foam.

23. The method of claim 21, further comprising the step of forming the first surface by aligning the first and second pieces of foam and the first reinforcing member.

24. The method of claim 23, further comprising the step of forming the first surface by cutting first and second pieces of foam and the first reinforcing member.

25. The method of claim 21, wherein the step of providing a first skin includes the step of providing a metal skin.

26. The method of claim 21, further comprising the step of providing a second reinforcing member,
wherein the step of forming a first planar surface further comprises forming the first planar surface including a surface from the second reinforcing member, and
wherein the step of forming a second planar surface further comprises forming the second planar surface including a surface from the second reinforcing member.

27. The method of claim 21, further comprising the step of providing a third piece of foam,
wherein the step of forming a first planar surface further comprises forming the first planar surface including a surface from the third piece of foam, and
wherein the step of forming a second planar surface further comprises forming the second planar surface including a surface from the third piece of foam.
